(19) United States
(12) Patent Application Publication
(10) Pub. No.: US 2010/0316250 A1
(43) Pub. Date: Dec. 16, 2010

(54) KEY IDENTIFYING DEVICE

(76) Inventor: Maximillian Perrigo, Ellensburg, WA (US)

Correspondence Address: BLACK LOWE & GRAHAM, PLLC, 701 FIFTH AVENUE, SUITE 4800, SEATTLE, WA, 98104, US

(21) Appl. No.: 12/482,166

(22) Filed: Jun. 10, 2009

(51) Int. Cl. G06K 9/00

(52) U.S. Cl. 382/100

(57) ABSTRACT

The present invention in its various versions includes devices and methods for recognizing, naming, storing, identifying, and reproducing keys. In one preferred example, a relatively small hand-held device includes a key-receiving slot having an internal scanner that captures an image of a key inserted into the slot. In a data storing mode, the key can be named and identified and then stored in memory. In a recognition mode, the scanned image of an inserted key is compared with previously stored keys to find a match. In the event a match is found, an associated display presents information identifying the key, such as the name of the key, the door or other locking device it is assigned to, or other desirable information.

### FIELD OF THE INVENTION

This invention relates generally to a device capable of reading, recording, and identifying keys for mechanical locks.

### BACKGROUND OF THE INVENTION

Many individuals commonly have a wide variety of keys for an equally wide variety of locks. For example, it is typical to have keys for many locks around a home, such as a lock for a front door, a back door, a garage door, and certain interior doors for bedrooms or bathrooms. In addition, storage sheds, lockers, and other facilities may have locks that use keys to open them. Office buildings and other work-related facilities likewise have many different locks for doors, gates, garages, lockers, and other areas.

In many cases, it can be difficult to keep track of the many different keys that one person might have. It can also be a challenge for a company to keep track of its many keys. When a reasonably large number of keys are involved, it can sometimes be virtually impossible to determine which lock goes with a particular key unless there are identifying indicia on the key. If there are not, the key may be essentially worthless. Unfortunately, there is nothing available today to readily identify an orphan key in order to associate it with a particular lock.

### SUMMARY OF THE INVENTION

The present invention in its various versions includes devices and methods for recognizing, naming, storing, identifying, and reproducing keys. In one preferred example, a relatively small hand-held device includes a key-receiving slot having an internal scanner that captures an image of a key inserted into the slot. In a data storing mode, the key can be named and identified and then stored in memory. In a recognition mode, the scanned image of an inserted key is compared with previously stored keys to find a match. In the event a match is found, an associated display presents information identifying the key, such as the name of the key, the door or other locking device it is assigned to, or other desirable information.

In other versions of the invention, the key reading and storage device may be connected to one or more other computers and additional databases over the Internet or other networks. In this fashion, the device may be communicatively coupled to a wide range of data such as key blank data relating types of keys to manufacturers and particular serial numbers or other codes.

Likewise, in some embodiments the scanned key data is stored on the reading device. In other versions it may be stored on a computer or a remote database associated with a remote server.

In additional versions of the invention the reading device may be connected to a computer-controlled key cutting machine in order to produce replacement keys in accordance with the prior scanned key image. Similarly, the scanned key image (or related data) may be provided over a network, a flash memory device, or by other means in order to facilitate its use by a computer-controlled key cutting device.

These and other examples of the invention are discussed in greater detail below.

### BRIEF DESCRIPTION OF THE DRAWINGS

Certain preferred examples of the invention are described below with reference to the following drawings. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a perspective view of a preferred key reading and storage device;

FIG. 2 is a perspective view of an exemplary key reading and storage device connected to a computer and peripheral equipment;

FIG. 3 is a top plan view of internal components within a preferred key reading and storage device;

FIG. 4 is a flow diagram for a preferred method of operation of an exemplary key reading and storage device;

FIGS. 5A-5C are screen displays for an exemplary key reading and storage device;

FIG. 6 is a perspective view of a preferred key reading and storage device connected to a cellular telephone;

FIG. 7 is a perspective view of a preferred key reading and storage device connected to a computer driven key cutting device; and

FIG. 8 is an illustration of a key profile showing preferred registration locations.

### DETAILED DESCRIPTION OF THE PREFERRED EMBODIMENT

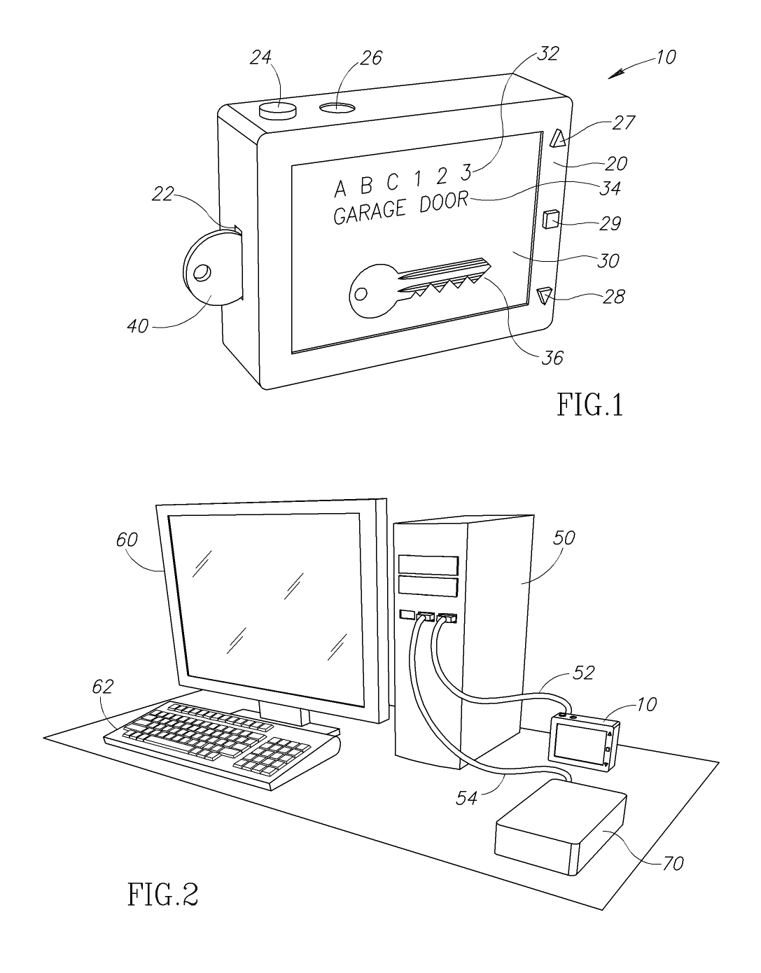

A preferred example of the invention is illustrated in FIG. 1. As shown, a key reading device 10 is configured to be able to scan a key, identify it, name it, and store it in memory. Previously stored keys can be scanned and matched against the previously stored data in order to identify the key and its associated lock.

The reading device 10 includes a substantially rigid outer case 20 having an external display 30. The display is configured to present information about the key such as a code 32 that may be a serial number, a key type, or a key manufacturer, for example. The display may also present additional information such as an indication 34 of the lock associated with the key. In some versions, the display may be large enough to also display an image 36 of the scanned key, including the cuts and grooves forming the key. The image may be an actual photographic or scanned image of the key, or may be an illustration representing the shape of the actual key. Yet other information may also be presented, with the amount of information only being limited by the size and capabilities of the display screen.

The housing 20 includes a slot 22 for receiving a key 40. As shown, the key 40 is extended into the interior of the device sufficiently to enable internal components to fully scan the teeth, grooves, and any other aspects of the working end of the key. In some versions of the invention, the slot allows the entire key to fit within the device, and the entire key is scanned. Though configured as a slot in the preferred form, in other versions of the invention the slot may be replaced with a door that is pivotably, slideably, or otherwise openable to allow the key to be placed in a scanning position. For example, a hinged door at the rear of the housing 20 may open in a pivotal fashion and snap shut to retain the key in place for scanning.

In the version as shown, the housing includes a power button 24 and a connection port for a USB or other computer communications cable 26. Bluetooth, infrared, or other wireless communications transceivers may also be provided in other examples of the invention, though they are not shown in the version of FIG. 1.

One or more buttons 27, 28, 29 are provided as a user interface. As discussed in greater detail below, the buttons allow the user to scroll up or down through a variety of menu options, as well as to indicate a selection of a desired menu item. Other user input structures are provided in different examples of the invention, such as incorporating a touch screen into the display 30.

In some examples of the invention, the device 10 is configured to communicate with an external computer. With reference to FIG. 2, the reading device 10 is connected by a USB cable 52 to a computer 50. The computer may be any microprocessor-based device, but as shown it includes a standard computer case having a microprocessor, memory, and optional equipment such as one or more disk drives. A computer display 60 and input device such as a keyboard 62 and a mouse or other pointing device (not shown) may also be included. Optionally, in some versions the computer includes a flat bed or other scanner 70 connected by a cable 54.

The computer provides several possible options for different versions of the device. In one form, the amount of memory on the reading device 10 is relatively small. The computer 50, on the other hand, has access to a larger memory storage. Moreover, the computer may be connected to any number of remote servers over the Internet or other communications channels to access larger amounts of data. Thus, the computer (directly or via the Internet) accesses a storage database of key types. When a key is scanned in the reading device 10, the reading device passes the scanned image data to the computer 50, which operates stored programming software to identify aspects of the key such as its length, width, head configuration and markings, and grooves. These aspects are compared with key type data on the computer 50 in order to determine the type and manufacturer of the key. This information is then passed to the reading device 10 where it is stored in the reading device's internal memory.

As will be discussed in greater detail below, a preferred reading device is configured to scan a key, name it, identify it, and store the associated data. In the version of FIG. 2, the naming function may also take place via the computer if desired. Thus, the keyboard 62 or other user input device may be used to enter a name or other identifying label for the scanned key, with that label being transferred to the reading device 10 for storage in a database linking the label with the other key information.

While a relatively small and portable key reading device 10 is the preferred form of the invention, in some versions the invention is implemented without a specially tailored device. Thus, in an alternate example of the invention, the key is read by a standard flat bed scanner 70 such as is shown in FIG. 2. Software stored on the computer identifies the key and allows the user to name it and store the associated information in the computer memory. As such, there is no need for the small portable reading device 10. In such a version of the invention, the invention is implemented generally in the form of a general purpose computer having appropriate software and peripheral devices, such as a scanner.

The data related to the key—such as its label, manufacturer, and type, are preferably stored on the reading device 10 and/or the computer 50. In addition, the key data may be stored remotely in a database associated with a remote server in communication with the reading device or the computer. Preferably, such storage would include encryption and passwords known only to the owner of the key (or a manufacturer, store owner, or other trusted agent) so that others could not access the key data in order to produce duplicate keys without the owner's permission.

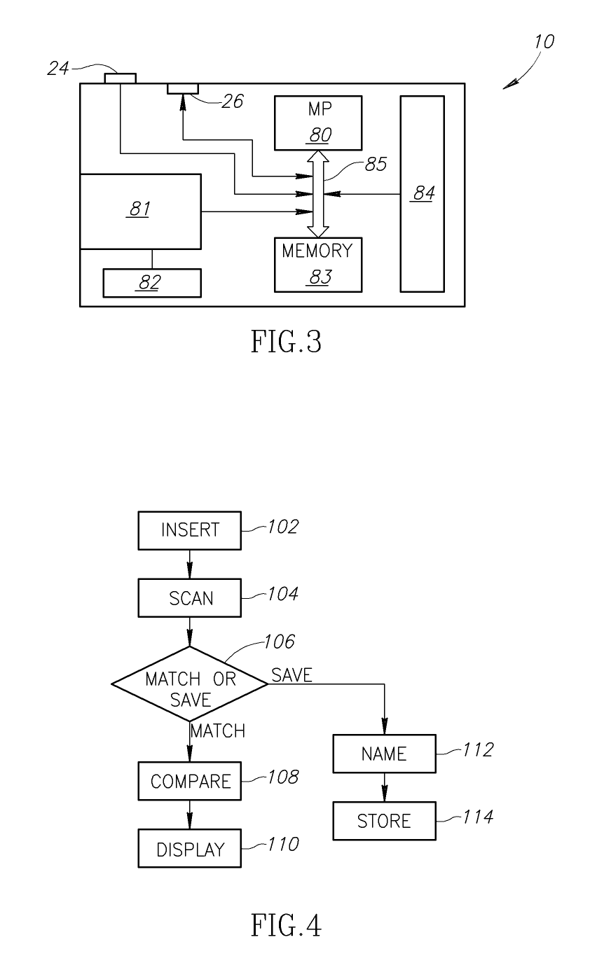

FIG. 3 illustrates a plan view of an interior of a preferred version of the key reading device 10. A scanning element 81 is provided adjacent the slot in the housing. The scanning element may take a variety of forms, depending on the desired cost of the particular implementation of the device. In one version, the scanning element may comprise a plurality of charge-coupled-device (CCD), CMOS, or other such elements such as are found in a typical digital camera. An appropriate lens is provided as necessary to focus the image scanning elements on the correct distance that is configured to hold the key to be scanned. Any hardware structure capable of capturing an image may be used for the scanning element.

A battery or other power source 82 is provided and is operably connected to the other internal components as necessary. An internal microprocessor 80 is operably connected via a data bus 85 to a memory 83 that is configured to hold key scanning and identifying software, key data, and other information. The memory is preferably flash memory, but can be any suitable form of computer-readable media. One or more user input devices 84 (such as buttons or a touch screen, as discussed above) are likewise in communication with the processor, either directly or via the communications bus 85. The power button 24 is also in signal communication with the processor, as is the communications port 26.

One preferred method of using the key reading and storing device is shown in the flow diagram of FIG. 4. At a first block 102, a key is inserted into the key receiving slot as described above. While this initial step is shown as the insertion of a key into a slot, it should be understood that it also applies equally well to the placement of the key onto a scanning surface that is protected by a sliding or pivoting door. For that matter, the scanning surface may reside simply on an outer surface of the housing of the device 10, thereby eliminating any need for a slot or door. Likewise, the insertion step includes the placement of a key onto a peripheral computer device such as a flatbed scanner that is configured to scan an image of the key and transfer it to a computer or other device.

After the key has been placed in an appropriate location to facilitate scanning, at a next block 104 an image of the key is scanned. The scanning image may be taken in any form such that an image of the key is captured in a computer-readable form. Preferably the scanning step obtains at least an outer image of the perimeter of the key, including the teeth. More preferably, the scanning step is configured to capture slots or grooves in the key, as well as the configuration of the head of the key. In yet more sophisticated versions of the invention, the scanned image is sufficiently detailed such that it captures etched, raised, printed, or other surface indicia on the key so that the indicia may be interpreted by the accompanying key interpretation software. The printed or other surface indicia may include, for example, the maker of the key and an indication of a type or category of the key. Preferably such information is scanned and the stored programming instructions are provided to use optical character recognition (OCR) to interpret such images and store them in a database associated with the key.

When a key has been inserted and its image scanned or captured, the method next queries whether the scanned key is intended to be added to the database of stored keys or compared with previously stored keys in the database to look for a match. Thus, at a next block 106, the method asks whether the user wants the system to look for a match or to save the key to the database.

If the user indicates a desire to add the key to the database, the method proceeds to a next block 112 where the user applies a name for the key. The naming step may be performed in a variety of ways, such as by selecting from a list of provided standard key names or by entering a custom name via a keyboard or other user input device. Once the key has been named, the method proceeds to a next block 114 at which point the data related to the scanned key image and the assigned name are saved in a key storage database.

Optionally the method may compare the scanned image against a stored database of key data to determine data related to the key type such as the manufacturer and the particular type of key blank from which the key was produced. The manufacturer and key blank data may be stored on the reader device, an associated computer, or on a remote server. In either case, the software stored on the device, the computer, or the server compares scanned key data against stored key data to try to find a match for the manufacturer and blank code. In many cases, the manufacturer can be determined by the configuration of the head of the key, while the blank code can be determined by the shape and grooves of the key. Likewise, raised or etched indicators on the head of the key may convey blank code information. Where the system has been able to determine a match by comparing scanned against stored data, it stores the associated manufacturer and key code data in association with the scanned key and assigned name.

Returning to block 106, if the user indicates the desire to find a match for the key, the method proceeds to a block 108 at which point the scanned image of the recently inserted key is compared with the scanned images of keys previously stored in the database. The key comparison routine preferably includes a comparison of the outline of the scanned key against the outlines of previously stored keys. For the majority of keys having a straight upper edge, the comparison routine aligns the straight upper edge of the scanned key against corresponding straight upper edges of stored scanned key images, then compares digital images of teeth profiles with respect to the straight upper edges. The routine may further compare key head outlines and groove profiles for matches.

After comparing the scanned image against stored images, the method may determine that it has found a match. In this sense, a match may be a perfect overlay of the key under investigation against the scanned image of a previously stored key. More likely, especially as the resolution of the scanned image increases, the scanned image will not result in a completely perfect match with any stored image. The deviations may be the result of, for example, slight differences in scanning angles caused by key insertion differences, dirt or other debris on the surface of a key, or wear to one or more of the teeth of a key over time. Thus, a match amounts to a substantial match in which the teeth and groove profiles for the scanned and stored keys are substantially the same.

When a match has been found, the display of the device indicates that there has been a match. In one example of the invention, as shown in FIG. 1, the display may indicate a key code for the matched key, the name of the key, and the scanned profile of the key. At that point the key reading and storage device has determined the identity of the previously unknown key.

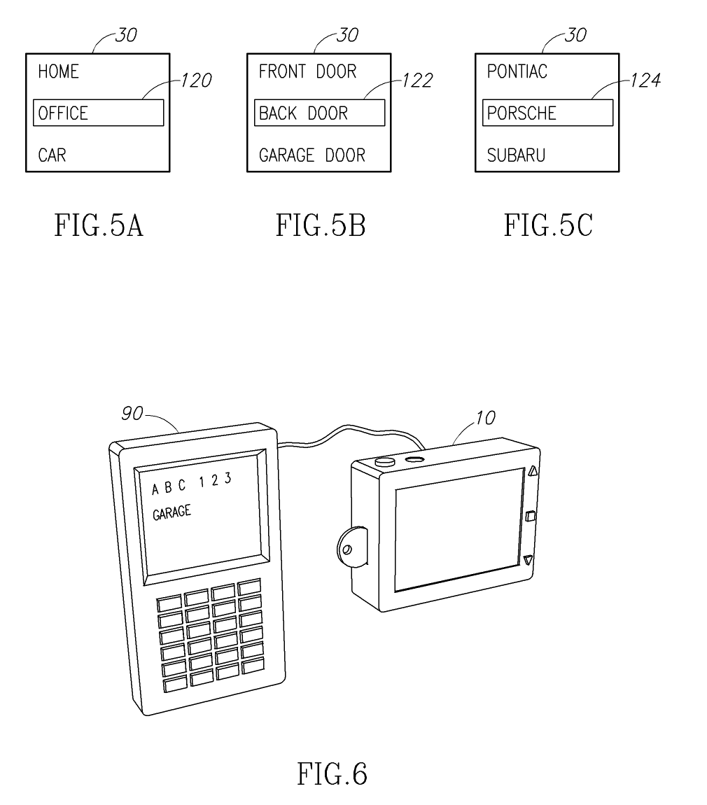

FIGS. 5A-5C depict some of the possible screen displays as the method of FIG. 4 is being followed. In one example, at the block 112 at which point the method applies a name to the key, the system may allow the name to be entered in a custom form by using a keyboard or other interface device that allows for a unique name entry. In a more simplified version of the invention, the device includes a plurality of preset key names and allows the user to choose from among them.

In the example of FIG. 5A, three names for Home, Office, and Car are shown. Using the up and down arrows 27, 28 of the user interface, a user is able to scroll up and down to see additional menu choices as desired and provided in any particular embodiment. Likewise, an “other” choice may appear at the end of the selection screen that enables the user to enter a specific name not provided on the preset listing. A selection box 120 indicates the name choice that is presently highlighted for selection. The user is able to confirm that selection by using the user interface for example, by pressing the button 29 on the outer surface of the housing or by touching the appropriate selection in a version that includes a touch screen.

The device may further include sub-menus for additional selections as desired. For example, if the “home” option is selected in FIG. 5A, the display 30 may present a sub-menu of preset choices related to a home, such as front door, back door, and garage door as illustrated in FIG. 5B. A selection box 122 is presented around the back door option, indicating that it is currently selected. The touch screen, button, or other user input device confirms the selection of the highlighted option, thereby associating that name with the scanned key.

Further sub-menus are also possible in other examples of the invention. Thus, as shown in FIG. 5C, the display 30 may include a preset listing of automobile makes or models such that the user may scroll through them and select a choice highlighted by a box 124 or other indicator.

Any number of additional menus and sub-menus may be included to facilitate the identification of a key and association with desired labels or other data. Likewise, the device may include a keypad or other form of text data entry (implemented on a touch screen or by other means) to allow the user to enter specifically tailored labels or other information associated with a key.

In an alternate version of the invention, the device is configured to present information on a PDA, cellular phone, or other hand-held device. Thus, as shown in FIG. 6, the device 10 is connected via a cable to a hand-held device 90 such as a cell phone. In such an embodiment, the key reading device may optionally not include a display screen of its own, but rather relies on the screen provided in the phone or hand-held device. While shown as a wired connection, the device 10 may alternatively be configured with Bluetooth, infrared, or other wireless communications transceivers to communicate with the hand-held device, preferably using data communication protocols that are readily available and commonly built into such hand-held devices.

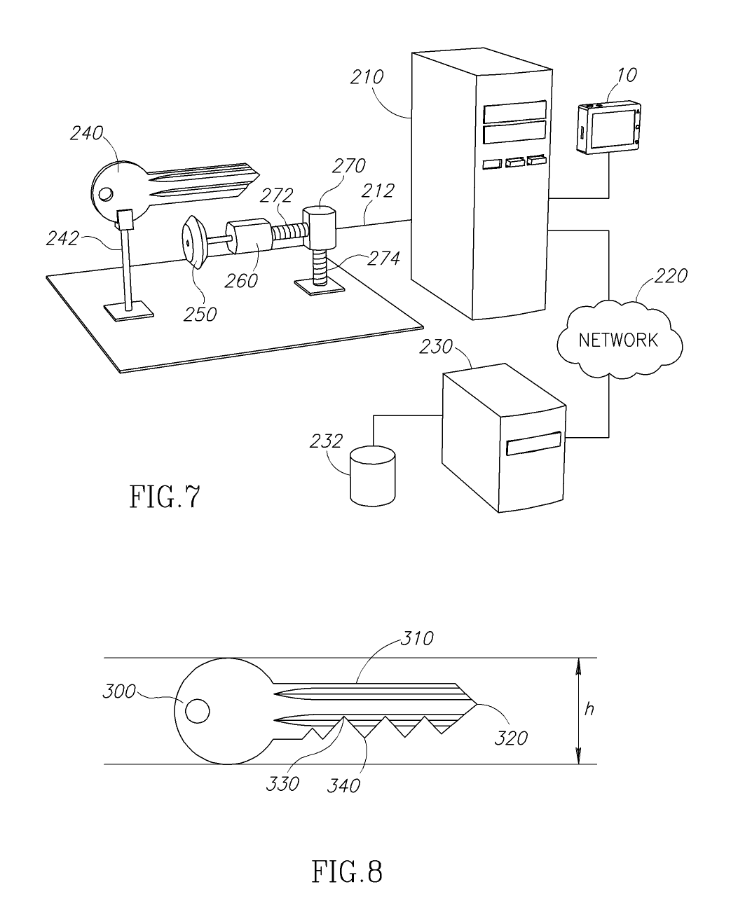

In yet another version of the invention, the key reading device is configured to facilitate an automated production of a key. As shown in FIG. 7, the key reading device 10 is connected to a computer 210 either through a wired or wireless communication channel. The computer 210 is preferably resident locally at a key cutting facility such as a hardware store or locksmith. The computer 210 further includes a display and input devices, not shown. The compute is configured to interact with a key cutting device in order to produce a key from the data stored in the key reading device.

The key reading device is illustrated as being connected directly to the computer 210. Alternatively, the key reading device may be connected to a user's personal computer as discussed above, with the personal computer being in communication with a server over the internet or other communications channels. The server 230 may include a database 232 that stores scanned key data along with other indicia such as the name of the key and the owner of the key. As discussed above, the information is preferably encrypted for security purposes. The server 230 is optionally in communication over the Internet 220 with the computer 210 in order to retrieve and transfer scanned key data to the computer in order to produce new keys from blanks. In this configuration, a computer maintained in communication with the server and a key cutting device may reproduce fresh keys at any location without having access to the original key.

The computer is shown as being in communication with a computer-controlled key cutting device. The key cutting device includes a key blank 240 mounted in a clamp 242 or other holding device so that the teeth may be cut into the blank. The cutting device further includes a grinding or cutting head or wheel 250 (or other means of cutting) secured to a motor 260 that provides an abrasive means of cutting the blank. The motor or cutting device is mounted so that the cutting head 250 is able to travel along at least two axes with respect to the key. Thus, as shown a drive motor 270 operates a first worm drive 272 in a horizontal direction and a second worm drive 274 in a vertical direction with respect to a horizontal axis defined by the length of the key 240. As the computer 210 is in communication with the drive motor to provide appropriate commands, the cutting head 250 travels up and down, left and right as appropriate to cut the desired teeth into the key.

It should be understood that other cutting equipment may be used to perform the task of cutting the key, and that the particular use of a motor driven cutting device with worm drive positional configurations is merely one example.

The scanned key data used to produce a key in the configuration as shown in FIG. 8 preferably includes sufficient data to allow automated key cutting. In one example, the stored information related to a key 300 includes reference information about a height h of the actual key blank in order to match up any scanned dimensions with actual dimensions. Thus, if it is known that a physical key is 0.5 inches in height and 1.5 inches in length, a scanned key image will be interpreted as appropriate using that dimensional information to determine true physical locations for the teeth.

Additional registration locations are also preferably used for particular keys. Thus, for example, a flat upper surface 310 and a tip of a key 320 may be identified in a scanned image. The combination of those known locations together with the known true dimensions allows the computer or the device to determine the precise measurements for locations along the teeth 330, 340 for precise computer-controlled cutting. Indeed, the entire key profile is readily determined in true physical dimensions from the registration or other reference points and an indication of the actual size of the key.

Many other changes can be made in light of the above detailed description. In general, in the following claims, the terms used should not be construed to limit the invention to the specific embodiments disclosed in the specification and the claims, but should be construed to include all types of remote controls, computers, and data communication means that operate in accordance with the claims. Accordingly, the invention is not limited by the disclosure, but instead its scope is to be determined entirely by the following claims.

The embodiments of the invention in which an exclusive property or privilege is claimed are defined as follows:

1. A key identifying device, comprising:
a microprocessor;
a scanner in communication with the microprocessor;
a memory in communication with the microprocessor; and
a housing retaining the microprocessor, the scanner, and the memory;
the memory further containing stored programming instructions operable by the microprocessor to cause the scanner to scan a key within a field of view of the scanner and to store a corresponding scanned key image and an associated label in the memory.

2. The device of claim 1, wherein the housing is configured to be hand-held.

3. The device of claim 1, further comprising a display on an external surface of the housing, whereby the stored programming instructions further cause the microprocessor to present on the display the scanned key image and the associated label.

4. The device of claim 1, further comprising a user input device.

5. The device of claim 4, wherein the user input device comprises one or more buttons.

6. The device of claim 1, wherein the display comprises a touch screen.

7. The device of claim 1, further comprising a slot formed in the housing, the slot being sized and configured to receive the key, the slot further being positioned with respect to the housing and the scanner such that when the key is inserted into the slot the key is within the field of view of the scanner.

8. The device of claim 1, further comprising an output port configured for communication with a personal computer.

9. The device of claim 1, further comprising a plurality of labels stored in the memory such that the label associated with the scanned key image is selectable from the plurality of stored labels.

10. The device of claim 1 wherein the stored programming instructions further cause the microprocessor to compare the scanned key image with one or more previously stored additional scanned key images and to indicate whether the scanned key image matches any of the one or more additional scanned key images.

11. The device of claim 10, wherein the device presents on the display the label associated with a matched scanned key image.

12. The device of claim 1, further comprising:
a computer in communication with the key identifying device; and
a computer-controlled key cutting device, the key cutting device being in communication with the computer and being configured to receive information related to the scanned key image from the computer.

13. A method for identifying a key, comprising:
scanning a profile of the key; and
comparing the scanned profile with at least one previously stored scanned key profiles to determine whether the scanned key profile matches the at least one stored key profiles.
